(19) United States
(12) Patent Application Publication
(10) Pub. No.: US 2022/0203832 A1
(43) Pub. Date: Jun. 30, 2022

(54) PROJECTION OPTICAL SYSTEM AND HEAD-UP DISPLAY DEVICE MOUNTED ON AUTOMOBILE

(71) Applicant: IVIEW DISPLAYS (SHENZHEN) COMPANY LTD., Shenzhen (CN)

(72) Inventors: Weizhan Zhu, Shenzhen (CN); Xiaofeng Tang, Shenzhen (CN); Mingnei Ding, Shenzhen (CN); Steve Yeung, Hong Kong (CN); Zhiqiang Gao, Hong Kong (CN)

(21) Appl. No.: 17/544,261

(22) Filed: Dec. 7, 2021

Related U.S. Application Data
(63) Continuation of application No. PCT/CN2021/083362, filed on Mar. 26, 2021.

(30) Foreign Application Priority Data
Dec. 28, 2020 (CN) 202011577373.7

(51) Int. Cl. B60K 35/00; G02B 13/22; G02B 27/10

(52) U.S. Cl. CPC B60K 35/00; G02B 13/22; B60K 2370/23; B60K 2370/1529; G02B 27/1066

(57) ABSTRACT

A projection optical system applicable to a head-up display device mounted on an automobile includes an image generation unit, a reflection unit, a double-telecentric lens, a light splitting device, and an imaging lens that are successively arranged in a light exit direction. The light splitting device needs to be arranged on an image side of the double-telecentric lens and configured to reflect a light beam for imaging in light beams emitted by the image generation unit. The double-telecentric lens is configured to adjust a size of the projection image. The imaging lens is configured to adjust a virtual image distance of the projection image and output the light beams of the projection image to achieve projection imaging.

### CROSS-REFERENCE TO RELATED APPLICATION

This application is based upon and claims priority to Chinese Patent Application No. 202011577373.7, filed before China National Intellectual Property Administration on Dec. 28, 2020 and entitled “PROJECTION OPTICAL SYSTEM AND HEAD-UP DISPLAY DEVICE MOUNTED ON AUTOMOBILE,” and PCT Application No. PCT/CN2021/083362, filed on Mar. 26, 2021 and entitled “PROJECTION OPTICAL SYSTEM AND HEAD-UP DISPLAY DEVICE MOUNTED ON AUTOMOBILE” the entire contents of which are incorporated herein by reference.

### TECHNICAL FIELD

Embodiments of the present disclosure relate to the technical field of projection optics, and in particular, relate to a projection optical system and a head-up display device mounted on an automobile.

### BACKGROUND

A head-up display (HUD) refers to a display mounted on a front windshield of an automobile. Nowadays, with transformation of the automobile towards intelligence, at present, newly designed intelligent automobiles are all mounted with HUDs, and drivers are capable of knowing speed, speed limitation signs, drive routes and the like vehicle information and road condition information with no need of lowering heads to check instrument panels. Augmented reality HUDs (AR HUDs) are prevailing currently. An AR HUD is a head-up display device capable of displaying AR pictures.

During practice of the present disclosure, the applicant has found that the related art at least has the following problem: At present, in HUDs mounted on automobiles, the size of a projection image and the virtual image distance of the projection image fail to be adjusted. With respect to different types of automobiles, postures of front windshields are different, and thus different imaging requirements are imposed. During setting of a projection optical system, the system needs to be redesigned to adapt to different automobiles. Once the setting is completed, it is difficult to adjust the setting.

### SUMMARY

With respect to the defects in the related art, objects of embodiments of the present disclosure are to provide a projection optical system capable of conveniently adjusting an imaging effect, and a head-up display device mounted on an automobile.

The objects of the embodiments of the present disclosure are achieved by employing the following technical solutions:

In view of the above technical problem, in a first aspect, the embodiments of the present disclosure provide a projection optical system applicable to a head-up display device mounted on an automobile. The projection optical system includes: an image generation unit, configured to emit light beams including image information of a projection image;

a reflection unit, a light incident side of the reflection unit being arranged in a light exit direction of the image generation unit;

a double-telecentric lens, a light incident side of the double-telecentric lens arranged in a light exit direction of a light reflection side of the reflection unit, and the double-telecentric lens being configured to adjust a size of the projection image;

a light splitting device, a light incident side of the light splitting device being arranged in a light exit direction of a light exit side of the double-telecentric lens, the light splitting device being arranged on an image side of the double-telecentric lens, and the light splitting device being configured to reflect a light beam for imaging in the light beams emitted by the image generation unit; and

an imaging lens, a light incident side of the imaging lens being arranged in a light exit direction of a light reflection side of the light splitting device, and the imaging lens being configured to adjust a virtual image distance of the projection image and output the light beams of the projection image to achieve projection imaging.

In some embodiments, the double-telecentric lens includes a first refractive lens group and a second refractive lens group; and the projection optical system further includes:

a controller, configured to adjust the size of the projection image by controlling positions of the first refractive lens group and the second refractive lens group in the double-telecentric lens; and

In some embodiments, the projection optical system further includes:

a first driving device, connected to the controller and the double-telecentric lens, and configured to drive, in response to a control instruction issued by the controller, the double-telecentric lens to adjust an image size of light exiting from the double-telecentric lens.

In some embodiments, the automobile further includes a front windshield, wherein the front windshield is a diffuser, and in the projection optical system, a relay image of the imaging lens is imaged on the front windshield; and the projection optical system further includes:

a second driving device, connected to the controller and the imaging lens, and configured to drive, in response to a control instruction issued by the controller, the imaging lens to adjust an imaging position of light exiting from the imaging lens.

In some embodiments, the projection optical system further includes:

a third driving device, connected to the controller and the light splitting device, and configured to drive, in response to a control instruction issued by the controller, the light splitting device to adjust a position of the light splitting device during adjustment of the image size by the double-telecentric lens, such that the light splitting device is arranged on an image side of the double-telecentric lens and capable of reflecting the emitted light beams.

In some embodiments, the reflection unit is a turning prism, arranged at a first predetermined angle between the image generation unit and the double-telecentric lens.

In some embodiments, an optical power of the imaging lens is 12 mm, and a focal length of the imaging lens is 8.6 mm.

In some embodiments, an optical power of the first refractive lens group is 15 mm, and a focal length of the first refractive lens group is 8.6 mm; and

an optical power of the second refractive lens group is 8 mm, and a focal length of the second refractive lens group is 6 mm.

In some embodiments, the image generation unit is a DLP display chip or an LCOS display chip.

In view of the above technical problem, in a second aspect, the embodiments of the present disclosure provide a head-up display device mounted on an automobile. The head-up display device includes the projection optical system according to the first aspect, wherein the projection optical system is capable of projecting an image onto a front windshield of the automobile such that imaging is achieved on the front windshield.

Compared with the related art, the present disclosure achieves the following beneficial effects: Different from the related art, the embodiments of the present disclosure provide a projection optical system applicable to a head-up display device mounted on an automobile. The projection optical system includes an image generation unit, a reflection unit, a double-telecentric lens, a light splitting device, and an imaging lens that are successively arranged in a light exit direction. The light splitting device needs to be arranged on an image side of the double-telecentric lens and configured to reflect a light beam for imaging in light beams emitted by the image generation unit. The double-telecentric lens is configured to adjust a size of the projection image. The imaging lens is configured to adjust a virtual image distance of the projection image and output the light beams of the projection image to achieve projection imaging. In the projection optical system according to the embodiments of the present disclosure, the size of the projection image is flexibly adjusted by the double-telecentric lens, and the virtual image distance of the projection image is flexibly adjusted by the imaging lens. Therefore, the projection optical system is applicable to head-up display devices mounted on different types of automobiles, and has the advantages of good imaging effect, small size, and low cost.

### BRIEF DESCRIPTION OF THE DRAWINGS

One or more embodiments are illustrated by way of example, and not by limitation, in the figures of the accompanying drawings, wherein elements/modules having the same reference numeral designations represent like elements/modules throughout. The drawings are not to scale, unless otherwise disclosed.

FIG. 1 is a schematic diagram of an application scenario of a projection optical system according to an embodiment of the present disclosure;

FIG. 2 is a schematic diagram of imaging on a front windshield in the application scenario in FIG. 1;

FIG. 3 is a schematic structural diagram of a projection optical system according to a first embodiment of the present disclosure;

FIG. 4 is a schematic diagram of an optical path in the projection optical system in FIG. 3;

FIG. 5 is a schematic structural block diagram of electrical connection of the projection optical system according to the first embodiment of the present disclosure; and

FIG. 6 is a schematic structural diagram of a head-up display device mounted on an automobile according to a second embodiment of the present disclosure.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

For clearer descriptions of the objectives, technical solutions, and advantages of the present disclosure, the present disclosure is further described with reference to specific embodiments and attached drawings. It should be understood that the specific embodiments described herein are only intended to explain the present disclosure instead of limiting the present disclosure.

It should be noted that, in the absence of conflict, embodiments of the present disclosure and features in the embodiments may be incorporated, which all fall within the protection scope of the present disclosure. In addition, although function module division is illustrated in the schematic diagrams of apparatuses, and in some occasions, module division different from the divisions of the modules in the apparatuses may be used. Further, the terms “first,” “second,” and the like used in this text do not limit data and execution sequences, and are intended to distinguish identical items or similar items having substantially the same functions and effects.

For ease of definition of the connection structure, positions of the components are defined using a light exit direction of a light beam as a reference. As used herein, the terms “upper,” “lower,” “left,” “right,” “vertical” “horizontal,” and the like expressions are used for illustration purposes only. For ease of definition of the connection structure, positions of the components are defined using a direction in which a light beam is incident to a light splitting device from a top-view direction as a reference.

Unless the context clearly requires otherwise, throughout the specification and the claims, technical and scientific terms used herein denote the meaning as commonly understood by a person skilled in the art. Additionally, the terms used in the specification of the present disclosure are merely for description of the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

To solve the technical problem that a size and a virtual image distance of a projection image fail to be adjusted in the conventional head-up display device mounted on an automobile, the embodiments of the present disclosure provide a projection optical system. In the projection optical system according to the embodiments of the present disclosure, the size of the projection image is flexibly adjusted by a double-telecentric lens, and the virtual image distance of the projection image is flexibly adjusted by an imaging lens. Therefore, the projection optical system is applicable to head-up display devices mounted on different types of automobiles, and has the advantages of good imaging effect, small size, and low cost.

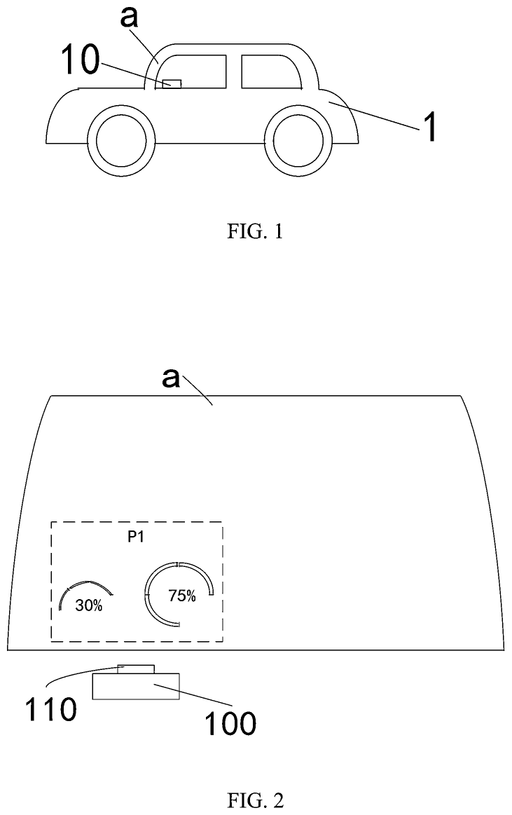

FIG. 1 is a schematic diagram of an application scenario of a projection optical system according to an embodiment of the present disclosure, and FIG. 2 is a schematic diagram of imaging on a front windshield in the application scenario in FIG. 1. The application scenario involves an automobile 1. The automobile 1 includes a front windshield a and a head-up display device 10.

The head-up display device 10 employs a projection optical system 100 according to the embodiment of the present disclosure to achieve imaging and display of two image pictures. The projection optical system 100 is capable of outputting a projection image P1 through an imaging lens 110.

In this application scenario, the projection image P1 may be configured to display a two-dimensional image, for example, driving information of the automobile 1, wherein the driving information includes, but is not limited to, speed information, oil supply information, and the like of the automobile 1. Accordingly, the automobile 1 should be equipped with a speed sensor, an oil supply sensor, and the like. Specifically, configurations of the two-dimensional image, the driving information of the automobile 1, and the corresponding sensor may be selected according to the actual needs, which are not limited to those in the application scenario of the present disclosure.

Alternatively, in this application scenario, the projection image P1 may also be configured to display a three-dimensional image, that is, an AR picture, for example, road condition information of a road where the automobile 1 is traveling, wherein the road condition information includes, but is not limited to, lanes, road lines, pedestrian crossings, obstacles, traffic lights, traffic sign boards, and the like. Accordingly, the automobile 1 should be equipped with a camera, a laser radar, and the like detection device. Further, where the automobile 1 is capable of implementing a navigation function, navigation indication information may also be over-displayed together with the road condition information. Specifically, configurations of the three-dimensional image, the road condition information of the road where the automobile 1 is traveling, and the corresponding detection device may be selected according to the actual needs, which are not limited to those in the application scenario of the present disclosure.

In this application scenario, the front windshield a is preferably made of a glass material that is capable of clearly achieving imaging and has a good light transmittance. Specifically, the material may be selected according to the actual needs, which is not limited to that in the application scenario of the present disclosure.

Hereinafter, the embodiments of the present disclosure are further illustrated with reference to the accompanying drawings.

### First Embodiment

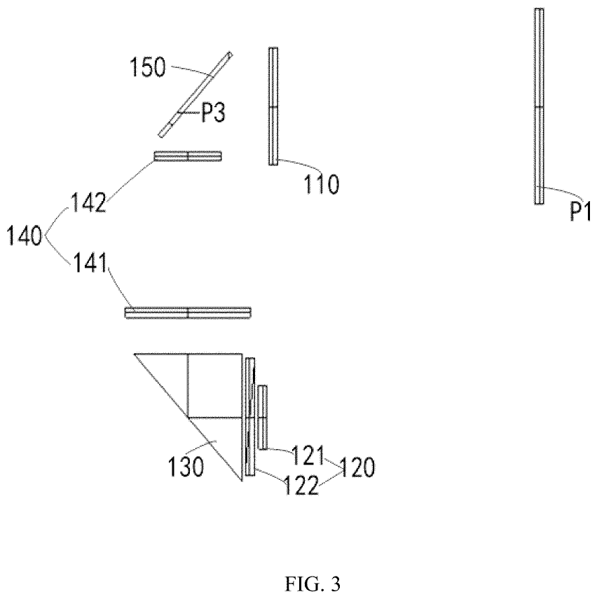

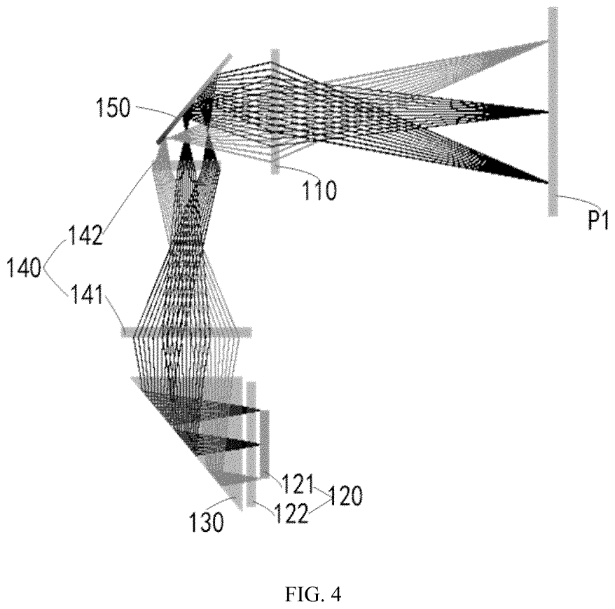

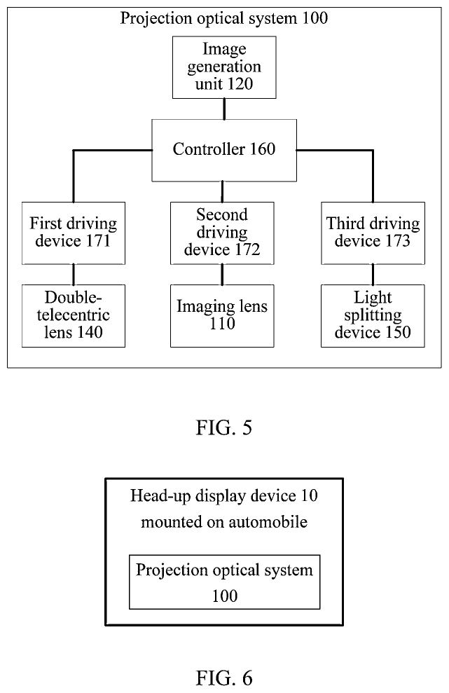

This embodiment of the present disclosure provides a projection optical system, which is applicable to a head-up display device as described in the above application scenario. Collectively referring to FIG. 3, FIG. 4, and FIG. 5, FIG. 3 is a structural diagram of a projection optical system 100 according to an embodiment of the present disclosure, FIG. 4 is a diagram of an optical path of the projection optical system in FIG. 3, and FIG. 5 is a structural block diagram of electrical connection of a projection optical system according to an embodiment of the present disclosure. The projection optical system 100 includes: an imaging lens 110, an image generation unit 120, a reflection unit 130, a double-telecentric lens 140, a light splitting device 150, a controller 160, a first driving device 171, a second driving device 172, and a third driving device 173.

The image generation unit 120 is configured to emit light beams including image information of a projection image. The image generation unit 120 is a digital light processing (DLP) display chip or a liquid crystal on silicon (LCOS) display chip. In the embodiment of the present disclosure, the image generation unit 120 includes an effective surface 121 and a projective glass 122. In other embodiments, the image generation unit 120 may also be a digital micromirror device (DMD) display chip or another image display chip, which may be specifically selected according to the actual needs, and is not limited to that in the embodiment of the present disclosure.

Alight incident side of the reflection unit 130 is arranged in a light exit direction of the image generation unit 120. The reflection unit 130 is a turning prism arranged at a first predetermined angle between the image generation unit 120 and the double-telecentric lens 140. The turning prism employed by the reflection unit 130 may be a total internal reflection (TIR) prism to achieve total reflection of the light beams. In the embodiment illustrated in FIG. 4, the reflection unit 130 employs a right angle prism. One right angle face is opposite to the image generation unit 120. The other right angle face is opposite to the double-telecentric lens 140. An inclined face of the reflection unit 130 has a reflection angle of 90 degrees, that is, the first predetermined angle of the reflection unit 130 is 45 degrees, and the reflection unit 130 is arranged in the optical path at the predetermined angle. In some other embodiments, the model and material of the reflection unit 130, and the first predetermined angle may be selected according to the actual needs, which are not limited to those in the embodiments of the present disclosure.

A light incident side of the double-telecentric lens 140 is arranged in a light exit direction of a light reflection side of the reflection unit 130. Further, the double-telecentric lens 140 includes a first refractive lens group 141 and a second refractive lens group 142, and the controller 160 is configured to adjust a size of the projection image by controlling positions of the first refractive lens group 141 and the second refractive lens group 142 in the double-telecentric lens 140; and the first driving device 171 is connected to the controller 160 and the double-telecentric lens 140, and configured to drive, in response to a control instruction issued by the controller 160, the first refractive lens group 141 and the second refractive lens group 142 to adjust image sizes of light exiting from the first refractive lens group 141 and the second refractive lens group 142. The first refractive lens group 141 has an optical power of 15 mm and a focal length of 8.6 mm, and the second refractive lens group 142 has an optical power of 8 mm and a focal length of 6 mm. Specifically, the first refractive lens group 141 and/or the second refractive lens group 142 may be a single lens or a lens group composed of a plurality of lenses, and may also contain other optical instruments. In practical application scenarios, the first refractive lens group 141 and/or the second refractive lens group 142 may be configured according to the actual needs, which are not limited to that in the embodiment of the present disclosure. It should be noted that the optical power and focal length of the first refractive lens group 141 and/or the second refractive lens group 142 are only design parameters obtained by software simulation in the embodiment as illustrated in FIG. 4 of the present disclosure. In practice, depending on different beam propagation paths, the specific design parameters of the first refractive lens group 141 and/or the second refractive lens group 142 may also be other parameters obtained according to software simulation. The examples according to the embodiments of the present disclosure are not intended to construe any limitation to the design parameters of the first refractive lens group 141 and/or the second refractive lens group 142 during the actual simulation or manufacturing.

A light incident side of the light splitting device 150 is arranged in a light exit direction of a light exit side of the double-telecentric lens 140 and the light splitting device 150 is arranged on an image side of the double-telecentric lens 140; and the light splitting device 150 has an optical power of 24 mm. In the embodiment of the present disclosure, the light splitting device 150 is a device configured to split the light beams of the projection image P1. Specifically, the light splitting device 150 reflects the light beams of the projection image P1 by reflection or the like fashions, and the reflected light beams enter the imaging lens 110. The light splitting device 150 may be made of an H-K9L colorless optical glass. In other embodiments, the material for manufacturing the light splitting device 150 and the color of the material may be selected according to the actual needs. Specifically, the material and the color of the material may be designed according to the actual needs, which are not limited to those in the embodiment and the drawing of the present disclosure. In some embodiments, the third driving device 173 is connected to the controller 160 and the light splitting device 150, and configured to drive, in response to a control instruction issued by the controller 160, the light splitting device 150 to move.

It should be noted that the optical power of the light splitting device 150 is only a design parameter obtained by software simulation in the embodiment as illustrated in FIG. 4 of the present disclosure. In practice, depending on different beam propagation paths, the specific design parameter of the light splitting device 150 may also be other parameters obtained according to software simulation. The examples according to the embodiments of the present disclosure are not intended to construe any limitation to the design parameter of the light splitting device 150 during the actual simulation or manufacturing.

It should be noted that during adjustment by the double-telecentric lens 140, the light splitting device 150 also needs to be correspondingly adjusted. Specifically, a center of the light splitting device 150 needs to be arranged on an image side of a relay image P3 imaged by the double-telecentric lens 140, and a position of the light splitting device 150 may be adjusted by using the third driving device 173, such that the light beams are normally imaged in response to being reflected or transmitted from the light splitting device 150.

A light incident side of the imaging lens 110 is arranged in a light exit direction of a light reflection side of the light splitting device 150; and the imaging lens 110 has an optical power of 12 mm, and the imaging lens 110 has a focal length of 8.6 mm. Specifically, the imaging lens 110 may be a single lens or a lens group composed of a plurality of lenses, and may also contain other optical instruments. In practical application scenarios, the imaging lens 110 may be configured according to the actual needs, which is not limited to that in the embodiment of the present disclosure. It should be noted that the optical power and focal length of the imaging lens 110 are only design parameters obtained by software simulation in the embodiment as illustrated in FIG. 4 of the present disclosure. In practice, depending on different beam propagation paths, the specific design parameters of the imaging lens 110 may also be other parameters obtained according to software simulation. The examples according to the embodiments of the present disclosure are not intended to construe any limitation to the design parameters of the imaging lens 110 during the actual simulation or manufacturing.

The controller 160 is connected to the image generation unit 120, the double-telecentric lens 140, the light splitting device 150, and the imaging lens 110, and configured to control the light beams emitted by the image generation unit 120, adjust an imaging size by adjusting the double-telecentric lens 140, and adjust an imaging distance by adjusting the imaging lens 110. The controller 160 may be various types of chips, modules, units, apparatuses and/or devices with a computing function, such as a processor and a server, commonly used for optical projection and capable of sending a control instruction. Further, the controller 160 may also have a computing function and/or a control function that projection devices usually have, such as communicating with the outside and/or accepting user gesture actions or instructions, and the like. Specifically, a corresponding controller 160 may be selected according to the actual needs, which is not limited to the embodiment of the present disclosure.

As described in the above application scenario, the automobile 1 further includes a front windshield a, and in the projection optical system 100, a relay image P1 of the imaging lens 110 is imaged on the front windshield a. In the embodiment of the present disclosure, the controller 160 is further connected to the imaging lens 110, and the controller 160 is configured to adjust, by controlling a position of the imaging lens 110, a virtual image distance of the projection image P1 in response to the projection image P1 being imaged on the front windshield a. Specifically, the second driving device 172 is connected to the controller 160 and the imaging lens 110, and configured to drive, in response to a control instruction issued by the controller 160, the imaging lens 110 to adjust an imaging position of light exiting from the imaging lens 110.

During displaying of two images by using the projection optical system according to the embodiment of the present disclosure, using the application scenarios as illustrated in FIG. 1 and FIG. 2 as examples, the image generation unit 120 plays the image information of the projection image P1, and emits light beams. The light beams are reflected by the reflection unit 130, and then enter the double-telecentric lens 140. Afterwards, the light beams are reflected by the light splitting device 150, and enter the imaging lens 110. The light beams, in response to exiting from the imaging lens 110, are projected on the front windshield a of the automobile 1, and hence the projection image P1 is displayed. Further, the distance and size of the virtual image presented on the front windshield a may also be adjusted by adjusting the focal length, or the position of the imaging lens 110, or even by using lenses of different magnifications, or the like. Further, the size of the virtual image presented on the front windshield a may also be adjusted by adjusting the focal lengths or positions of the first refractive lens group 141 and/or the second refractive lens group 142 in the double-telecentric lens 140, or even by using lenses of different magnifications, or the like. In addition, upon adjustment of the double-telecentric lens 140, the position of the light splitting device 150 needs to be correspondingly adjusted.

It should be noted that the first driving device 171, the second driving device 172 and/or the third driving device 173 may respectively drive the double-telecentric lens 140, the imaging lens 110, and/or the light splitting device 150 mechanically, may respectively drive the double-telecentric lens 140, the imaging lens 110, and/or the light splitting device 150 in a software drive fashion, or may respectively drive the double-telecentric lens 140, the imaging lens 110, and/or the light splitting device 150 in a software-plus-hardware fashion. For example, these elements are driven by using a servo/a motor, or driven by wired/wireless connection between the controller 160 and a server/a system/an electronic device, or driven by using a switch transistor/a switch circuit, and the like. Specifically, configurations may be made according to the actual needs, which are not limited to those in the embodiment of the present disclosure.

### Second Embodiment

This embodiment of the present disclosure provides a head-up display device mounted on an automobile. The automobile may be the automobile 10 as described in the above mentioned application scenario, and the head-up display device may be the head-up display device as described in the above mentioned application scenario. Referring to FIG. 6, a structure of a head-up display device 10 mounted on an automobile according to an embodiment of the present disclosure is illustrated. The head-up display device 10 includes the projection optical system 100 as described in the first embodiment, wherein the projection optical system 100 is capable of projecting the projection image P1 onto the front windshield a of the automobile 10 to achieve imaging.

It should be noted that the specific structure of the projection optical system 100 is as described in the first embodiment, and reference may be made to the description of the projection optical system 100 in the first embodiment, which is not described in detail herein.

The embodiments of the present disclosure provide a projection optical system applicable to a head-up display device mounted on an automobile. The projection optical system includes an image generation unit, a reflection unit, a double-telecentric lens, a light splitting device, and an imaging lens that are successively arranged in a light exit direction. The light splitting device needs to be arranged on an image side of the double-telecentric lens and configured to reflect a light beam for imaging in light beams emitted by the image generation unit. The double-telecentric lens is configured to adjust a size of the projection image. The imaging lens is configured to adjust a virtual image distance of the projection image and output the light beams of the projection image to achieve projection imaging. In the projection optical system according to the embodiments of the present disclosure, the size of the projection image is flexibly adjusted by the double-telecentric lens, and the virtual image distance of the projection image is flexibly adjusted by the imaging lens. Therefore, the projection optical system is applicable to head-up display devices mounted on different types of automobiles, and has the advantages of good imaging effect, small size, and low cost.

It should be noted that the above described device embodiments are merely for illustration purpose only. The units which are described as separate components may be physically separated or may be not physically separated, and the components which are illustrated as units may be or may not be physical units, that is, the components may be located in the same position or may be distributed into a plurality of network units. Part or all of the modules may be selected according to the actual needs to achieve the objectives of the technical solutions of the embodiments.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A projection optical system, applicable to a head-up display device mounted on an automobile, the system comprising:
an image generation unit, configured to emit light beams comprising image information of a projection image;
a reflection unit, a light incident side of the reflection unit being arranged in a light exit direction of the image generation unit;
a double-telecentric lens, a light incident side of the double-telecentric lens arranged in a light exit direction of a light reflection side of the reflection unit, and the double-telecentric lens being configured to adjust a size of the projection image;
a light splitting device, a light incident side of the light splitting device being arranged in a light exit direction of a light exit side of the double-telecentric lens, the light splitting device being arranged on an image side of the double-telecentric lens, and the light splitting device being configured to reflect a light beam for imaging in the light beams emitted by the image generation unit; and
an imaging lens, a light incident side of the imaging lens being arranged in a light exit direction of a light reflection side of the light splitting device, and the imaging lens being configured to adjust a virtual image distance of the projection image and output the light beams of the projection image to achieve projection imaging.

2. The projection optical system according to claim 1, wherein
the double-telecentric lens comprises a first refractive lens group and a second refractive lens group; and the projection optical system further comprises:
a controller, configured to adjust the size of the projection image by controlling positions of the first refractive lens group and the second refractive lens group in the double-telecentric lens.

3. The projection optical system according to claim 2, further comprising:
a first driving device, connected to the controller and the double-telecentric lens, and configured to drive, in response to a control instruction issued by the controller, the double-telecentric lens to adjust an image size of light exiting from the double-telecentric lens.

4. The projection optical system according to claim 3, wherein
the automobile further comprises a front windshield, wherein the front windshield is a diffuser, and in the projection optical system, a relay image of the imaging lens is imaged on the front windshield; and the projection optical system further comprises:
a second driving device, connected to the controller and the imaging lens, and configured to drive, in response to a control instruction issued by the controller, the imaging lens to adjust an imaging position of light exiting from the imaging lens.

5. The projection optical system according to claim 4, further comprising:
a third driving device, connected to the controller and the light splitting device, and configured to drive, in response to a control instruction issued by the controller, the light splitting device to adjust a position of the light splitting device during adjustment of the image size by the double-telecentric lens, such that the light splitting device is arranged on an image side of the double-telecentric lens and capable of reflecting the emitted light beams.

6. The projection optical system according to claim 5, wherein the reflection unit is a turning prism, arranged at a first predetermined angle between the image generation unit and the double-telecentric lens.

7. The projection optical system according to claim 6, wherein an optical power of the imaging lens is 12 mm, and a focal length of the imaging lens is 8.6 mm.

8. The projection optical system according to claim 7, wherein
an optical power of the first refractive lens group is 15 mm, and a focal length of the first refractive lens group is 8.6 mm; and
an optical power of the second refractive lens group is 8 mm, and a focal length of the second refractive lens group is 6 mm.

9. The projection optical system according to claim 8, wherein the image generation unit is a DLP display chip or an LCOS display chip.

10. A head-up display device mounted on an automobile, comprising a projection optical system, wherein the projection optical system comprises:
an image generation unit, configured to emit light beams comprising image information of a projection image;
a reflection unit, a light incident side of the reflection unit being arranged in a light exit direction of the image generation unit;
a double-telecentric lens, a light incident side of the double-telecentric lens arranged in a light exit direction of a light reflection side of the reflection unit, and the double-telecentric lens being configured to adjust a size of the projection image;
a light splitting device, a light incident side of the light splitting device being arranged in a light exit direction of a light exit side of the double-telecentric lens, the light splitting device being arranged on an image side of the double-telecentric lens, and the light splitting device being configured to reflect a light beam for imaging in the light beams emitted by the image generation unit; and
an imaging lens, a light incident side of the imaging lens being arranged in a light exit direction of a light reflection side of the light splitting device, and the imaging lens being configured to adjust a virtual image distance of the projection image and output the light beams of the projection image to achieve projection imaging, wherein
the projection optical system is capable of projecting an image onto a front windshield of the automobile such that imaging is achieved on the front windshield.

11. The head-up display device mounted on an automobile according to claim 10, wherein
the double-telecentric lens comprises a first refractive lens group and a second refractive lens group; and the projection optical system further comprises:
a controller, configured to adjust the size of the projection image by controlling positions of the first refractive lens group and the second refractive lens group in the double-telecentric lens.

12. The head-up display device mounted on an automobile according to claim 11, wherein the projection optical system further comprising:
a first driving device, connected to the controller and the double-telecentric lens, and configured to drive, in response to a control instruction issued by the controller, the double-telecentric lens to adjust an image size of light exiting from the double-telecentric lens.

13. The head-up display device mounted on an automobile according to claim 12, wherein
the automobile further comprises a front windshield, wherein the front windshield is a diffuser, and in the projection optical system, a relay image of the imaging lens is imaged on the front windshield; and the projection optical system further comprises:
a second driving device, connected to the controller and the imaging lens, and configured to drive, in response to a control instruction issued by the controller, the imaging lens to adjust an imaging position of light exiting from the imaging lens.

14. The head-up display device mounted on an automobile according to claim 13, wherein the projection optical system further comprising:
a third driving device, connected to the controller and the light splitting device, and configured to drive, in response to a control instruction issued by the controller, the light splitting device to adjust a position of the light splitting device during adjustment of the image size by the double-telecentric lens, such that the light splitting device is arranged on an image side of the double-telecentric lens and capable of reflecting the emitted light beams.

15. The head-up display device mounted on an automobile according to claim 14, wherein the reflection unit is a turning prism, arranged at a first predetermined angle between the image generation unit and the double-telecentric lens.

16. The head-up display device mounted on an automobile according to claim 15, wherein an optical power of the imaging lens is 12 mm, and a focal length of the imaging lens is 8.6 mm.

17. The head-up display device mounted on an automobile according to claim 16, wherein
an optical power of the first refractive lens group is 15 mm, and a focal length of the first refractive lens group is 8.6 mm; and
an optical power of the second refractive lens group is 8 mm, and a focal length of the second refractive lens group is 6 mm.

18. The head-up display device mounted on an automobile according to claim 16, wherein
the image generation unit is a DLP display chip or an LCOS display chip.
